(19) United States
(12) Patent Application Publication
(10) Pub. No.: US 2011/0177401 A1
(43) Pub. Date: Jul. 21, 2011

(54) Lithium-air cell protective membranes comprising polytetrafluoroethylene coated fiberglass cloth

(76) Inventors: Owen Crowther, Philadelphia, PA (US); David Chua, Wayne, PA (US); William Eppley, Skippack, PA (US); Benjamin Meyer, Lansdale, PA (US); Mark Salomon, Little Silver, NJ (US); Arthur Driedger, Spring City, PA (US); Michael Morgan, Spring City, PA (US)

(21) Appl. No.: 12/928,763

(22) Filed: Dec. 17, 2010

Related U.S. Application Data
(63) Continuation-in-part of application No. 12/657,481, filed on Jan. 21, 2010.

(51) Int. Cl. H01M 8/22; H01M 8/04

(52) U.S. Cl. 429/405; 429/516

(57) ABSTRACT

Advanced lithium-air semi-fuel cell with non-aqueous electrolyte solution is provided, having higher energy density over the prior art cells, due to its protective, oxygen selective, permeable membrane of PTFE coated fiberglass cloth, placed over the cathode outer surface. Said membrane is flexible and protects the cell from moisture and evaporation of said electrolyte, which substantially minimizes parasitic losses of lithium and increases the cell efficiency and safety. The membrane may also have a layer of air-permeable adhesive added, facing said cathode.

### CROSS REFERENCE TO RELATED DOCUMENTS

This patent application is a continuation in part of the David Chua et al., patent application Ser. No. 12/657,481, filed on Jan. 21, 2010, entitled, “Protected Lithium-Air Cells by Oxygen-Selective Permeable Cathode Membranes”.

### BACKGROUND OF THE INVENTION

1. Field of the Invention

This invention pertains mostly to lithium-air cells and batteries comprising lithium-metal anode, electrically non-conductive porous separator and electrically conductive porous carbon cathode, all activated by ionically conductive, non-aqueous liquid electrolyte; and sealed in a moisture-proof enclosure, which enclosure includes an oxygen-selective permeable membrane over the cathode outer surface. Both electrodes have metal current collectors with terminals exiting the sealed enclosure. Other metal anodes are also useable in this cell structure.

2. Description of the Prior Art

Lithium-air semi-fuel cells, also referred to as lithium-air cells or batteries, are basically composed of a metallic lithium anode and an air (O₂) fuel cell type cathode. The air electrode serves to provide an interface where O₂ from air is catalytically reduced on the active components of a porous cathode, which is commonly carbon with or without a catalyst to enhance the rate of O₂ reduction. To enhance the electrochemical reduction of oxygen in the cathode, one approach is to employ an aprotic solvent in which the solubility and diffusibility of gaseous oxygen is very large (as described in the publications of Read, and Kowalczyk et al.). However, many of these aprotic solvents have high vapor pressures and can rapidly diffuse out of the cell, resulting in rapid cell failure. By utilizing an aprotic solvent such as an organic-based, or ionic liquid-based electrolyte solution, the products of the cell reactions are insoluble Li₂O and Li₂O₂. For lithium-air semi-fuel cell, the overall (mixed) cell reactions in organic electrolyte solutions are:

2Li+½O₂→Li₂O

2Li+O₂→Li₂O₂

Because both Li₂O and Li₂O₂ are not soluble in these aprotic electrolyte solutions, both oxides will precipitate in pores of the porous carbon-based cathode which blocks further O₂ intake, and thus ends cell life. Even with this limitation, lithium-air semi-fuel cells still represent a major advance since the practical achievable specific capacities and specific energies for non-aqueous lithium-air cells are extremely higher than those achievable by lithium-ion batteries and other metal-air aqueous cells as shown in Table 1.

TABLE 1
Theoretical Specific Energy and Capacity
Comparisons for Selected Systems

| | | Specific | Specific |
|---|---|---|---|
| Metal-Air and Li-Ion Systems | OCV | Energy | Capacity |
| (aprotic or aqueous electrolyte solution) | (V) | (Wh/kg) | (mAh/g) |
| 2Li + ½O₂ → Li₂O (aprotic) | 2.913 | 11,248* | 3,862 |
| Li + ½O₂ → ½Li₂O₂ (aprotic) | 2.959 | 11,425* | 3,862 |
| 2Li + ½O₂ + H₂SO₄ [symbol] Li₂SO₄ + H₂O | 4.274 | 2,046* | 479 |
| (aq) | | | |
| 2Li + ½O₂ + 2HCl [symbol] 2LiCl + H₂O | 4.274 | 2,640* | 616 |
| (aq) | | | |
| 2Li + ½O₂ + H₂O [symbol] 2LiOH (aq) | 3.446 | 5,789* | 1,681 |
| Al + 0.75O₂ + 1.5H₂O → Al(OH)₃ (aq) | 2.701 | 4,021* | 1489 |
| Zn + ½O₂ → ZnO (aq) | 1.650 | 1,353* | 820 |
| x6C + LiCoO₂ [symbol] xLiC₆ + Li₁₋ₓCoO₂ | ~4.2 | 420** | 140 |
| (aprotic) | | | |

*The molecular mass of O₂ is not included in these calculations because O₂ is freely available from the atmosphere and therefore does not have to be stored in the battery or cell.
**Based on x = 0.5 in Li₁₋ₓCoO₂.

The major problems of the prior art lithium-air cells and batteries are:
1. The ingress of atmospheric water through the air cathode into the aprotic electrolyte solution, which is a significant safety hazard, due to the reaction of water with metallic lithium, and which is also causing destruction of lithium salt and thus conductivity and additional parasitic capacity loss of lithium of the anode, resulting in much shorter discharge time.
2. Evaporation of solvent components of the aprotic electrolyte solution through the porous carbon-based cathode, resulting in decreasing ionic conductivity and eventual cell shutdown when most or all solvents have been lost due to evaporation through the cathode into the atmosphere.

To address these problems, others have proposed to protect the lithium anode by a sealed, ion conductive ceramic glass layer, such as described in U.S. Pat. No. 7,282,295 of Visco. However, this ceramic is very brittle and size limited. Also, it adds weight and cost, and does not prevent evaporation of the liquid electrolyte from the cathode, and increases cell resistance. Abraham in U.S. Pat. No. 5,510,209 proposes plastic adhesive tape covering the cathode before the cell use. However, during the cell use, the water ingress causes the damage and low efficiency described above. The instant invention provides a solution of these problems by having the outer surface of the carbon-based air cathode and thus the whole cell protected by various inert and flexible fiberglass membranes, coated by PTFE, which are specific for oxygen permeability, while simultaneously preventing permeation of water vapor and organic solvents through these protective membranes.

### SUMMARY OF THE INVENTION

Now it has been found, that substantially longer operational time, efficiency and safety of lithium-air cells and batteries with non-aqueous electrolytes over the prior art cells can be accomplished by protection of cathode outer surface with various oxygen-selective permeable membranes. The present invention pertains to several new technologies developed to extend the operational time and safety of lithium-air cell or battery which utilize electrolyte solutions based on aprotic solvents. These technologies also increase energy density of the cells, due to increased efficiency. The invention can be applied to any type of lithium-air cell, including the cells in which the metallic lithium anode is protected by a glass-ceramic membrane, or a lithium-air cell in which metallic lithium is separated from the cathode by a polymer gel or a porous inert micro-porous membrane containing an aprotic electrolyte solution. Loss of aprotic solvent components from the electrolyte solution and water ingress for both types of lithium-air cells is prevented by applying a protective layer of fiberglass cloth, coated by PTFE, to the outer surface of the carbon-based cathode. By “outer surface” of the air electrode, is meant, the surface facing the atmosphere. The PTFE coated fiberglass cloths used for this invention are those capable of permitting entry of large quantities of oxygen into the cathode from the atmosphere (about 21% by volume), often selectively over nitrogen, which is the major component of air (about 78%). Other desirable properties of these oxygen-selective permeable membranes include their resistance to dissolution in water and/or polar aprotic solvents, which are the components of electrolyte solutions for use in the lithium-air cells of this invention. The high performance membranes include both commercially available fiberglass cloths (two examples are items 8577K81 and 76495A58 from McMaster-Carr Supply Company in Elmhurst, Ind., and similar materials fabricated “in-house”. Furthermore, the PTFE coated fiberglass cloth may consist of an additional layer composed of a silicone adhesive. This layer would help to deter the ingress of water vapor and the egress of the electrolyte solvent as demonstrated further below. For the purpose of the lithium-air semi-fuel cells of this invention, the oxygen selective components described above can be directly applied to the carbon-based cathode, or applied over another membrane such as Porex (PTFE), or a micro-porous poly-alkyl membrane (e.g. polyethylene (PE), polypropylene (PP) and blends of PE and PP). The membranes may be also sealed to the hermetic enclosure of the cell, around the cathode edges. Due to the flexibility of these materials placed on the outer surface of the carbon-based cathode, the lithium-air semi-fuel cells of this invention will also exhibit high flexibility, thus permitting various designs or configurations in manufacturing, e.g. prismatic and cylindrical constructions. These and other features of lithium-air semi-fuel cells of this invention are described below.

The principal object of this invention is to provide higher energy density lithium-air semi-fuel cell over the prior art cells, due to its protection of lithium salts, aprotic electrolytes, and lithium anodes from water, and due to prevention of evaporation of electrolytes.

Another object of this invention is to provide more efficient and safer lithium-air semi-fuel cell. Other objects and advantages of the invention will be apparent from the description and claims.

### BRIEF DESCRIPTION OF THE DRAWINGS

The nature and characteristic features of the invention will be more readily understood from the following description taken in connection with accompanying drawing, in which:

FIG. 1 illustrates schematic, sectional side view of lithium-air semi-fuel cell of this invention, showing:

The metallic lithium anode pressed onto a metal current tab of a non-amalgam forming metal such as Ni or Cu;
The lithium anode in contact with an aprotic organic or ionic liquid based electrolyte solution embedded in an inert porous inert host, referred to as a lithium-compatible Li⁺-conductive electrolyte;
The porous carbon-based cathode where atmospheric oxygen is electrochemically reduced;
The PTFE coated fiberglass cloth membrane, covering the outer surface of the cathode and preventing components of the internal aprotic electrolyte solution from evaporating into the atmosphere and atmospheric water vapor from entering the cell, and
the moisture-proof housing enclosing the cell.

FIG. 2 is showing discharge of lithium-air semi-fuel cells in air at 40-50% relative humidity with a fiberglass cloth tape coated with PTFE and a silicone adhesive, compared to a Porex control.

FIG. 3 is showing pictures of the lithium anode after discharge using the (left) PTFE coated fiberglass cloths with silicone adhesive and (right) Porex control membrane.

FIG. 4 is showing discharge of a 100 cm² lithium-air semi-fuel cell using PTFE coated fiberglass cloths with silicone adhesive as a cathode protective membrane in wet air.

FIG. 5 is showing discharge capacities in wet air of lithium-air semi-fuel cells using PTFE coated fiberglass cloths as a function of current density.

FIG. 6 is showing electrolyte evaporation rates when using the PTFE coated fiberglass cloths with and without the silicone adhesive and the Porex control membrane.

FIG. 7 is showing water ingress rates when using the PTFE coated fiberglass cloths with and without the silicone adhesive and the Porex control membrane.

It should, of course, be understood that the description and the drawings herein are merely illustrative, and it will be apparent that various modifications, combinations and changes can be made of the structures and the systems disclosed without departing from the spirit of the invention and from the scope of the appended claims.

### DETAILED DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Lithium-air semi-fuel cell usually comprises lithium-metal anode foil or sheet, electrically insulated porous separator and porous carbon cathode sheet or plate, all saturated with ion conductive, non-aqueous electrolyte, and enclosed in a housing having an opening (s) for air access to the cathode. The lithium-anode may be also protected by a sealed around ceramic, ion-conductive sheet with a non-aqueous electrolyte between the ceramic and the anode, such as described by Visco in U.S. Pat. No. 7,282,295, and by Kowalczyk et al. in U.S. Pat. No. 7,842,423, which are incorporated herein by reference.

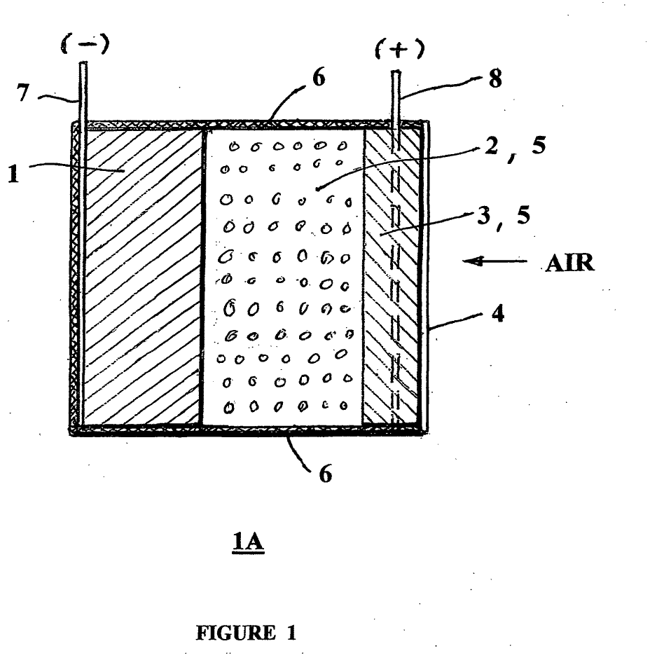

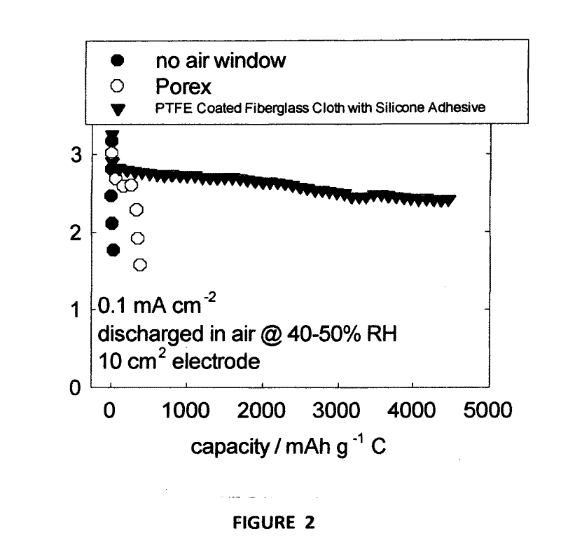

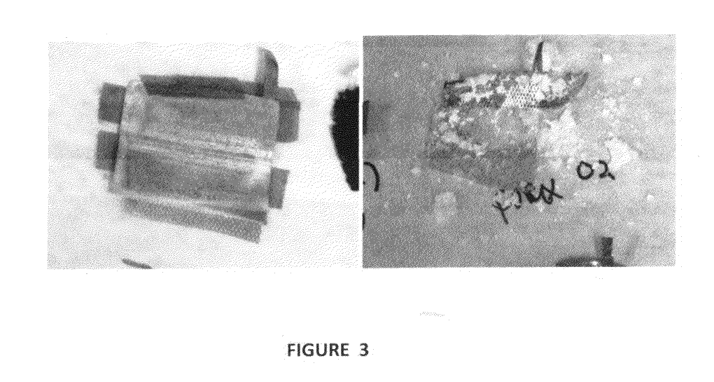

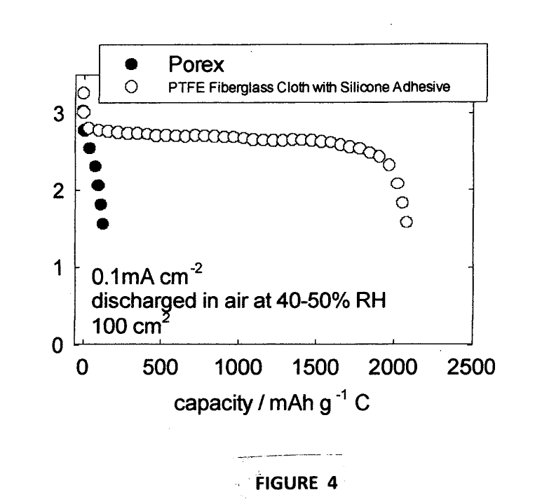

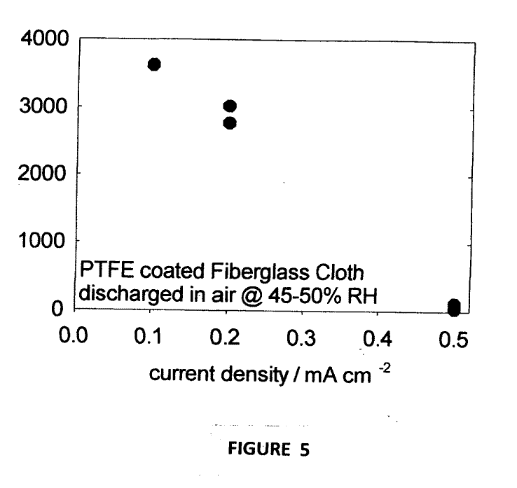

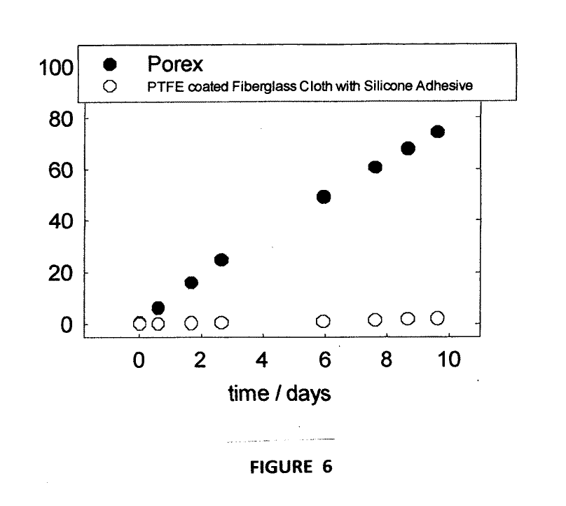

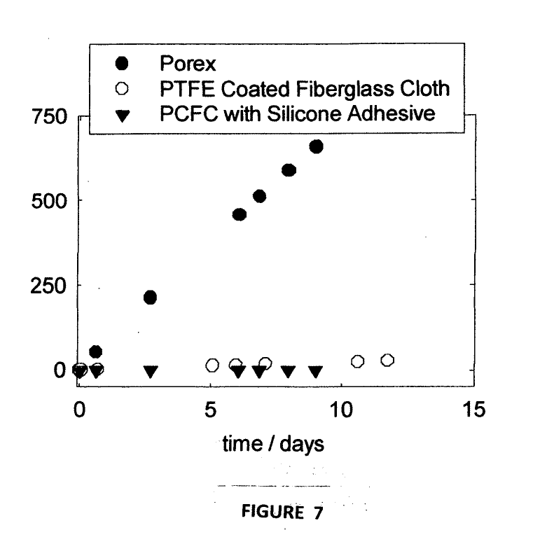

Referring now in more detail and particularly to FIG. 1, which is one embodiment of the invention, showing the sectional side view of the lithium-air semi-fuel cell 1A, which comprises:

lithium anode 1, porous separator 2, porous carbon cathode 3, oxygen-selective, permeable fiberglass membrane 4, lithium-ion conductive, non-aqueous electrolyte 5, anode metal current collector 7, and porous metal cathode current collector 8, both exiting from cell housing 6.

A variety of different cell packaging can be used. The housing 6 must seal the lithium-air semi-fuel cell to only permit transfer of oxygen through the cathode protection membrane 4.

The anode current collector 7 is a metal material that does not alloy with the lithium anode 1, usually copper or nickel.

The cathode current collector 8 is a metal material that will not corrode at high voltages, i.e. aluminum or nickel.

The instant invention pertains to several new technologies developed to extend the operational time and safety of a lithium-air cell or battery, which utilize electrolyte solutions based on aprotic solvents. This technology also increases energy density of the cells, due to increased efficiency. The invention can be applied to any type of lithium-air semi-fuel cell, including the cells in which the metallic lithium anode is protected by a glass-ceramic membrane, or lithium-air semi-fuel cells in which metallic lithium is separated from the cathode by a polymer gel or a porous, inert micro-porous membrane containing a non-aqueous electrolyte solution. Loss of aprotic solvents from the electrolyte solution and water ingress for both types of lithium-air semi-fuel cells is prevented by applying a protective layer of fiberglass cloth coated by PTFE 4, to the outer surface of the carbon-based cathode. By outer surface of the air electrode, is meant, the surface facing the atmosphere. The PTFE coated fiberglass cloth material may be heat-sealed, sealed using an o-ring, or sealed via another method to the housing 6. A PTFE coated fiberglass cloth membrane with air permeable silicone adhesive may also be taped directly to the cathode 3 or to the cell housing 6. The membrane layers 4 used for this invention are those capable of permitting entry of large quantities of oxygen into the cathode from the atmosphere (about 21% by volume), often selectively over nitrogen which is the major component of air (about 78% by volume). Other desirable properties of these oxygen-selective permeable membranes include their resistance to dissolution in water and polar aprotic solvents, which are the components of electrolyte solutions for use in the lithium-air semi-fuel cells of this invention.

An aprotic organic or ionic liquid based electrolyte solution is contained in the inert porous host separator 2 and the porous carbon cathode 3. The separator 2 is flooded with the electrolyte solution while the porous cathode 3 may or may not be flooded with electrolyte solution.

When the cell 1A of the invention is connected to an electrical load, lithium-ions flow from the anode 1 through the separator 2 to the cathode 3 oxygen, providing electric current.

For the purpose of the lithium-air cells of this invention, the oxygen selective membranes described above may be directly applied to the carbon-based cathode 3. The membranes may be also hermetically sealed to the hermetic enclosure of the cells, around the cathode edges.

Due to the flexibility of these membranes placed onto the outer surface of flexible carbon-based cathode, the lithium-air cells of this invention will also exhibit high flexibility, thus permitting various designs or configurations in manufacturing, e.g. prismatic and cylindrical constructions.

While the membranes are available commercially from many sources, their use in a lithium-air semi-fuel cell is novel. The PTFE coated fiberglass cloths may or may not contain additional layers to further retard water ingress and electrolyte egress, improve mechanical strength, and/or seal the cell via the use of an adhesive. The basic properties of the materials disclosed in this invention are high selectivity for oxygen permeability and transport, their negligible ability to dissolve and transport water vapor and aprotic solvents commonly used in all types of lithium batteries, e.g. alkyl and cyclic carbonates, esters and ethers. There are many building block materials which exhibit these properties, and examples of some preferred materials to be used for protection of lithium-air semi-fuel cell are disclosed below.

These materials include:

Commercially available PTFE coated fiberglass cloths; Examples of this material include, but are not limited to, the following items available from McMaster-Carr Supply Company (Elmhurst, Ind.): 8577K81, 8577K82, 8577K83, 8577K84, 8577K85, 8577K86, 8665K81, 8665K82, 8665K83, 8665K84, 8876K81, 8876K82, 8776K83, and 8776K84. This also includes other commercially available PTFE coated fiberglass cloths available from McMaster-Carr Supply Company as well as other companies.
Commercially available PTFE coated fiberglass cloths with silicone adhesive; These hold the additional advantage as being able to seal the cell shut. Examples of this material include, but are not limited to, the following items available from McMaster-Carr Supply Company (Elmhurst, Ind.): 5739T11, 5739T31, 5739T51, 5737T21, 76495Axx where xx=12, 14, 16-19, 22, 24, 26-29, 31-39, 41, 51-59, 61-69, 71-74, 81, 82, 84, 85, 91, and 92, and 7649Axx where xx=33, 35, 36, 41-49, 61-64, 71-73, 81-83, and 91-93. This also includes other commercially available PTFE coated fiberglass cloths with silicone adhesive available from McMaster-Carr Supply Company as well as other companies.
Other materials; either available commercially or fabricated “in-house” that consist of similar materials to those described in this patent that are used a cathode protective membrane in a lithium-air semi-fuel cell.
PTFE coated fiberglass cloths coated with additional layers; that are used as cathode protection membranes in lithium-air semi-fuel cells. One example of this material is the commercially available PTFE coated fiberglass cloth with silicone adhesive discussed above. The additional layers may serve the purpose to further retard water ingress and electrolyte egress, improve mechanical strength, seal the cell via the use of an adhesive, and/or other things. Other adhesives, such as acrylic, polyurethane and epoxide are also useable. Preferably, the described adhesives are deposited only on the high points of the woven cloths, which make them scattered and thus air-permeable.

As discussed above, the material can be manufactured “in-house” or purchased commercially. Even though they are available commercially, their use in a lithium-air semi-fuel cell as a cathode protection membrane is novel. If manufactured “in-house” using an adhesive, the adhesive can be applied to one of the substrates discussed below or directly to the cathode via any of the following methods, as well as methods not mentioned herein: dip-coating, doctor-blading, spin-coating, spraying, smearing, etc.

Application of the above building-block materials to the outer surface of the air cathode can be accomplished by direct application of said cloths to the air cathode.

There is no limitation on the type or air cathode which can be used in this invention. Commercial air cathodes from ETEK or Electric Fuel Ltd can be used as well as custom designed air cathodes based on carbons well known to practioners in the art of fabricating and manufacturing fuel cell and lithium-air semi fuel cell cathodes. Carbons such as Super P, Vulcan XC-72, Black Pearls 2000, and Ketjen Blacks 300 and 600 are preferred examples.

### EXAMPLES

The following example provides details of lithium-air semi-fuel cell performance at room temperature in wet air using concepts of this invention. These examples are provided to clearly illustrate the principles of this invention and are not intended to be limiting.

### Example 1

### A Lithium-Air Semi-Fuel Cell with Using a High Performance Tape Consisting of PTFE Coated Fiberglass Cloth with a Silicone Adhesive

A lithium-air semi-fuel cell depicted in FIG. 1, which is one embodiment of the invention, was built using a cathode consisting of approximately 80% Ketjen Black EC600G carbon and 20% Teflon. The thickness of the cathode was approximately 0.014 cm and the exposed outer surface area was 10 cm². The electrolyte solution used was 1.0 mol dm⁻³ LiBF₄ in a 1:1 mixture by volume of propylene carbonate (PC) and dimethyl carbonate (DMC). A Tonen E20 separator was used to keep the lithium anode and the cathode from shorting. PTFE coated fiberglass cloth with silicone adhesive was placed over a Porex membrane to allow oxygen into the cathode. The area for oxygen transmission was 10 cm². FIG. 2, which is another embodiment of the invention, shows the voltage profile of this cell when discharged at a rate of 0.1 mA cm⁻² in air at 40-50% RH. The cell discharged for over 6 days (>4000 mAh g⁻¹ C). FIG. 3, which is another embodiment of the invention, (left) is a picture of the anode after the discharge described above. The lithium anode has no visible signs of corrosion, showing the PTFE coated fiberglass cloth tape with silicone adhesive stopped water vapor from entering the lithium-air semi-fuel cell. FIG. 4, which is another embodiment of the invention, shows the discharge of a cathode with a similar composition and thickness, but with a 100 cm² area. This figure demonstrates the concepts discussed here are scalable.

### Example 2

### Rate Capabilities of Lithium-Air Semi-Fuel Cell Discharged in Wet Air Using PTFE Coated Fiberglass Cloth as a Protective Cathode Membrane

FIG. 5, which is another embodiment of the invention, shows the rate capabilities discharge of a lithium-air semi-fuel cell in wet air. The cells are identical to the cells described in example 1 except for the PTFE coated fiberglass cloth has no silicone adhesive layer. The cells demonstrate high discharge capacities at current densities less than 0.2 mA cm². However, the discharge capacities at 0.5 mA cm⁻² are extremely small suggesting the membrane cannot transfer enough O₂ to support this discharge rate. This data suggests this material can support a discharge rate between 0.2-0.5 mA cm⁻² in wet air.

### Example 3

### Water Vapor Ingress and Electrolyte Evaporation Through PTFE Coated Fiberglass Cloth with a Silicone Adhesive

FIG. 6, which is another embodiment of the invention, shows the rate of electrolyte evaporation through the PTFE coated fiberglass cloth with silicone adhesive. Dimethyl carbonate (DMC) is a common electrolyte solvent with a high volatility. The mass of DMC in a vial sealed closed with the high performance tape was measured periodically. After 10 days only 2.1 mass % of the DMC had evaporated. FIG. 7, which is another embodiment of the invention, shows the amount of water that passes through the membrane over 9 days was 1.352 mg. FIG. 7 also shows that the PTFE coated fiberglass cloth without silicone adhesive allows 24.6 mg of water vapor through over 10.6 days. These numbers will be compared to the case without cathode protection in Comparative Example #2 to demonstrate the invention's ability to act as a cathode protective membrane.

### Comparative Examples

In FIGS. 2-7, the discharge curves labeled “Porex” represent the discharge of a lithium-air semi-fuel cell depicted in FIG. 1 without any protection applied to the outer surface of the cathode. Porex is a porous Teflon membrane that freely allows electrolyte evaporation and the ingress of water vapor. Details are given in Comparative Example 2 below.

### Comparative Example 1

### Lithium-Air Semi-Fuel Cell without Protection of the Cathode

A lithium-air semi-fuel cell was built the same as the high performance tape protected cell in FIG. 2. A thin Teflon-based membrane such as Porex or a membrane described in U.S. Pat. No. 5,441,823 was pressed onto the outer surface of the cathode, i.e. the surface facing the atmosphere. Porex shows little resistance to the transfer of O₂ and water vapor. The thickness of the cathode was 0.15 mm, and the exposed outer surface area was 10 cm². The electrolyte solution used was 1.0 mol dm⁻³ LiBF₄ in a 1:1 mixture by volume of propylene carbonate (PC) and dimethyl carbonate (DMC). The cell was discharged at the same time and in the same environment as the 10 cm² cell also shown in FIG. 2. The cell that was protected by a PTFE coated fiberglass cloth with silicone adhesive had a capacity more than 11 times greater than the unprotected cell. The lithium anode is also completely corroded as seen in FIG. 3, whereas the protected cell's anode is still pristine. The 100 cm² cell shown in FIG. 4 delivers almost 16 times the capacity when using PTFE coated fiberglass cloth with silicone adhesive for cathode protection.

### Comparative Example 2

### Electrolyte Evaporation and Water Ingress Rates of Cells without Cathode Protection

FIG. 6 shows the DMC evaporation rate through Porex. The evaporation is slowed by a factor of 37 when high performance tape is used as cathode protection. FIG. 7 shows the rate of water vapor transport across the respective membranes. Nearly 500 times the amount of water passes through the Porex membrane in the same time frame as the PTFE coated fiberglass cloth with silicone adhesive.

There are many alternate ways of implementing processes for protecting the air electrode, and the present invention is not limited to the details herein.

All references cited herein are incorporated by reference for all purposes.

It should, of course, be understood that the description and the drawings herein are merely illustrative, and it will be apparent that various modifications, combinations and changes can be made of the structures and the systems disclosed without departing from the spirit of the invention and from the scope of the appended claims.

We claim:

1. A lithium-air semi-fuel cell, which comprises:
A lithium metal anode with a metal current collector electroconductivity attached to said anode;
an electrically conductive porous carbon cathode coated onto a porous metal current collector;
said cathode having inner and outer surface;
an electrically non-conductive porous separator, saturated with lithium-ion conductive non-aqueous electrolyte there-between and in contact with said anode and with said cathode inner surface;
a moisture-proof, electrically insulating housing, which housing encloses said anode, said cathode and said separator with said electrolyte;
and said housing having an opening facing said cathode outer surface, and said opening is covered by an oxygen-selective permeable, moisture-proof membrane of polytetrafluoroethylene coated fiberglass cloth, hermetically sealed to said housing;
and said current collectors are exiting from said housing in hermetically sealed manner, and are electrically insulated from said housing.

2. A lithium-air semi-fuel cell as described in claim 1, in which said anode is additionally protected by a hermetically sealed, ionically conductive moisture-proof ceramic layer, facing said cathode inner surface, and said cell having a lithium-ion conductive non-aqueous liquid electrolyte layer between said anode and said ceramic layer.

3. A lithium-air semi-fuel cell as described in claim 1, in which said oxygen-selective permeable membrane has additional permeable adhesive layer(s) to further retard ingress of water and egress of electrolyte.

4. A lithium-air semi-fuel cell as described in claim 3, in which said additional layers are made of adhesive materials selected from the group consisting of silicone, acrylic, polyurethane, and epoxide.

5. A lithium-air semi-fuel cell as described in claim 3, in which said oxygen-selective permeable membrane with said adhesive layer(s) is covering said opening in overlaying relation, and is applied directly to said cathode outer surface.

6. A lithium-air semi-fuel cell as described in claim 1, in which said oxygen-selective permeable membrane is flexible.

7. A lithium-air semi-fuel cell as described in claim 1, in which said non-aqueous electrolyte includes a salt selected from the group comprising: LiPF₆, LiBF₄, LiN(SO₂C₂F₅)₃, LiSO₃CF₃, LiClO₄, and their mixtures.

8. A lithium-air semi-fuel cell as described in claim 1, in which said electrolyte solvents are selected from the group comprising propylene carbonate, gamma-butyrolactone, ethylene carbonate, methylethyl carbonate, dimethyl carbonate, dimethoxy ethane, an ionic liquid such as 1-butyl-1-methylpyrrolidinium imide, 1-ethyl-3-methylimidazolium bisperfluoroethylsulfonyl imide, 1-ethyl-3-methylimidazolium bisperfluoroethylsulfonyl imide, and their mixtures.

9. A lithium-air semi-fuel cell as described in claim 1, in which said separator is a polymer electrolyte, in which the host polymer is PVdF, ethymethyl methacrylate, polyacrylonitrile, and their mixtures and alloys.

10. A lithium-air semi-fuel cell as described in claim 9, in which said polymer electrolyte plasticizers are solvents as described in claim 8, and in which said polymer electrolyte salts are as described in claim 7.

11. A cathode for lithium-air semi-fuel cell having inner and outer surface in relation to said cell, which cathode includes an oxygen selective permeable membrane made of polytetrafluoroethylene coated fiberglass cloth, facing said outer surface.

12. A cathode for lithium-air semi-fuel cell as described in claim 11, in which said oxygen selective permeable membrane has additional air-permeable adhesive layer(s) to further retard ingress of water and egress of electrolyte.

13. A cathode for lithium-air semi-fuel cell as described in claim 12, in which said additional layer(s) are made of adhesive materials selected from the group consisting of silicone, acrylic, polyurethane, and epoxide.

14. A cathode for lithium-air semi-fuel cell as described in claim 12, in which said adhesive layer(s) is (are) applied directly to said cathode outer surface.

15. A cathode for lithium-air semi-fuel cell as described in claim 11, in which said oxygen-selective permeable membrane is flexible.

16. An oxygen selective permeable membrane made of polytetrafluoroethylene coated fiberglass cloth, which is used for protection of lithium-air semi-fuel cells from water, and which also retards egress of electrolyte from said semi-fuel cells.

17. A membrane as described in claim 16, which additionally includes air-permeable adhesive layer(s) to further retard said ingress of water and egress of said electrolyte.

18. A membrane as described in claim 17, in which said layer(s) are made of adhesive materials selected for the group consisting of silicone, acrylic, polyurethane, and epoxide.

19. A membrane, as described in claim 17, in which said adhesive layer(s) is (are) applied directly to said semi-fuel cell surface.

20. A membrane, as described in claim 16, which is flexible.
